(19) United States
(12) Patent Application Publication
(10) Pub. No.: US 2014/0097343 A1
(43) Pub. Date: Apr. 10, 2014

(54) Spectroscopic Detector And Corresponding Method

(71) Applicants: Serge Gidon, La Murette (FR); Sergio Nicoletti, Sinard (FR); Jean-Louis Ouvrier-Buffet, Sevrier (FR)

(72) Inventors: Serge Gidon, La Murette (FR); Sergio Nicoletti, Sinard (FR); Jean-Louis Ouvrier-Buffet, Sevrier (FR)

(73) Assignee: Commissariat A L'Energie Atomique Et Aux Energies Alternatives, Paris (FR)

(21) Appl. No.: 14/119,510

(22) PCT Filed: May 31, 2012
(86) PCT No.: PCT/IB2012/052746

§ 371 Date: Nov. 22, 2013

(30) Foreign Application Priority Data
May 31, 2011 (FR) 11 54768

(51) Int. Cl. G01J 3/28

(52) U.S. Cl. CPC G01J 3/2803
USPC 250/339.02; 29/600

(57) ABSTRACT

The invention relates to a spectroscopic detector, including: at least one waveguide (70) arranged on a substrate (7) and having an input surface (700) to be connected to an electromagnetic source, in particular an infrared source, and a mirror (701) on the opposite surface, so as to generate a standing wave inside the waveguide; and a means for detecting electromagnetic radiation, which output an electrical signal according to the local intensity of the electromagnetic wave, characterised in that said detection means consists of suspended membrane bolometers (72 to 75) distributed between the input surface and the mirror, each membrane of said heat detectors being separated from said at least one waveguide by anchoring points (42) on said substrate (7), and in that means (702 to 705) for sampling a portion of the electromagnetic wave is provided between the input surface and the mirror.

The invention relates to the field of electronic detectors for providing spectral information of an electromagnetic field.

Detectors of this type are known but they have the disadvantage of being limited to a narrow spectral field.

Document FR-2 879 287 describes a spectroscopic detector operational for a spectral width of the order of the bandwidth of a waveguide.

This detector comprises a waveguide having an input face and a mirror on the opposite face, wherein a standing wave is created.

This detector also comprises light-sensitive local detectors adjacent the waveguide and regularly distributed between the input face and the mirror of the waveguide.

These detectors allow the intensity of the evanescent waves from the waveguide to be sampled. Thanks to sampling of the signals provided by the local detectors and to suitable processing, it is possible to obtain the spectrum of the standing wave created in the waveguide.

Moreover, it has been envisaged that this type of spectroscopic detector be used to detect gas.

This spectroscopic detector has the advantage of being miniaturized to micron scale. Yet, gas detection devices are most frequently designed in macroscopic optics, which has led to cumbersome systems.

However, this spectroscopic detector was, until now, only produced to operate within the visible range.

Indeed, it refers to microbolometers via superconducting wires. Yet, these microbolometers need to be cooled to the operating temperature of the superconductor, which is between 1 K and 100 K. Therefore, the detector must be placed into a cryogenic enclosure which is complex to achieve. Furthermore, in this temperature range, the optical properties of the materials are not known. Moreover, document FR-2 879 287 does not describe any practical embodiment of a spectroscopic detector including microbolometers of this type.

Yet, it appears necessary to have available detectors which also operate in the infrared range, the wavelength of which is between approximately 1 μm and 1000 μm.

Furthermore, in the prior art, thermal detectors are produced in the form of discrete components. Therefore, the production of the device incorporating detectors thermally is inevitably complicated.

Moreover, bolometers are known which are produced on a CMOS circuit. However, they are assembled, as discrete elements, with other constituent elements. Yet the techniques for assembling discrete elements are complex and pose alignment and precision problems.

This is why the aim of the invention is also to simplify the production of the spectroscopic detector.

Therefore, the invention relates to a spectroscopic detector comprising at least one waveguide arranged on a substrate and having an input face intended to be connected to an electromagnetic source, in particular an infrared source, and a mirror on the opposite face, so as to generate a standing wave within the waveguide, and means for detecting electromagnetic radiation delivering an electrical signal dependent upon the local intensity of the electromagnetic wave, characterized in that said detection means are suspended-membrane bolometers, distributed between the input face and the mirror, each membrane of said detectors being spaced from said at least one waveguide by anchoring points on said substrate and in that means for sampling a part of the electromagnetic wave are provided between the input face of the guide and the mirror.

Therefore, the detector comprises a single substrate carrying both said at least one waveguide and the heat detectors.

In a first alternative, the sampling means are produced at the surface of the waveguide.

They can particularly be made up of blocks arranged on the surface of the waveguide and produced from a material with an index which is different to that of the surrounding environment or of the waveguide.

These sampling means can also be continuity breaks produced at the surface of the waveguide.

The detector can include a cover to allow the bolometers to be placed under vacuum.

This cover can be shared by all of the bolometers.

It can also be made up of a plurality of individual covers each intended for a bolometer.

In the latter case, each individual cover supports a reflector intended for the bolometer covered by said cover.

In a particular embodiment, several detectors according to the invention are used while being arranged to form a matrix.

The invention also relates to a gas detector comprising a spectroscopic detector according to the invention.

Finally, the invention relates to a method of manufacturing a spectroscopic detector including the following steps wherein:
a waveguide is produced on a substrate, the waveguide having an input face intended to be connected to an electromagnetic source, in particular an infrared source, and a mirror on the opposite face, so as to generate a standing wave within the waveguide;
means for sampling a part of the electromagnetic wave are produced between the input face and the mirror;
a plurality of suspended-membrane bolometers is simultaneously produced on said substrate, which deliver an electrical signal dependent upon the local intensity of the electromagnetic wave, each membrane being spaced from the waveguide by anchoring points on the substrate.

The invention will be better understood and other aims, advantages and features thereof will emerge more clearly upon reading the following description with reference to the appended drawings wherein:

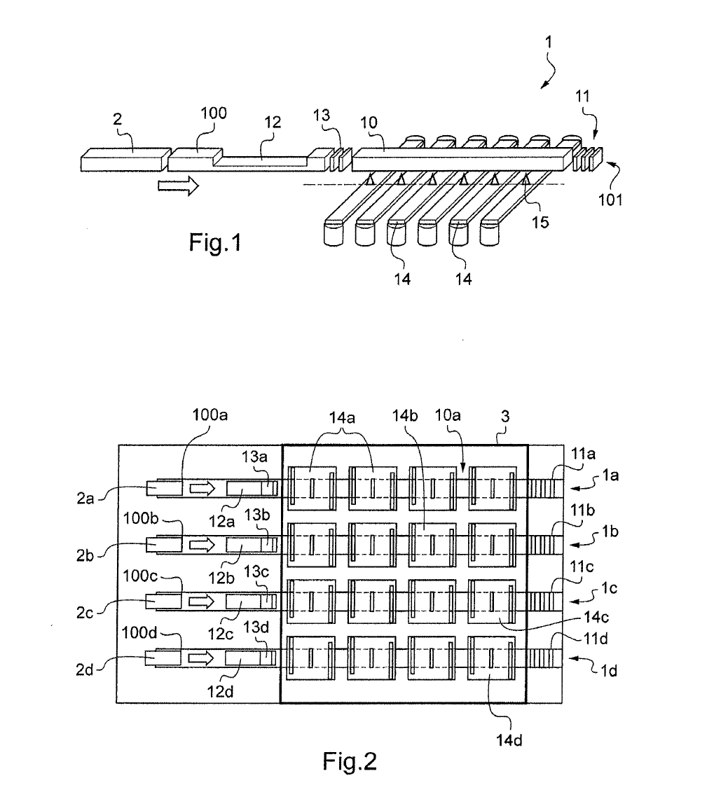

FIG. 1 is a perspective schematic view of a detector example according to the invention, which is used as a gas detector,

FIG. 2 is a plan of a matrix of spectroscopic detectors according to the invention, using bolometers,

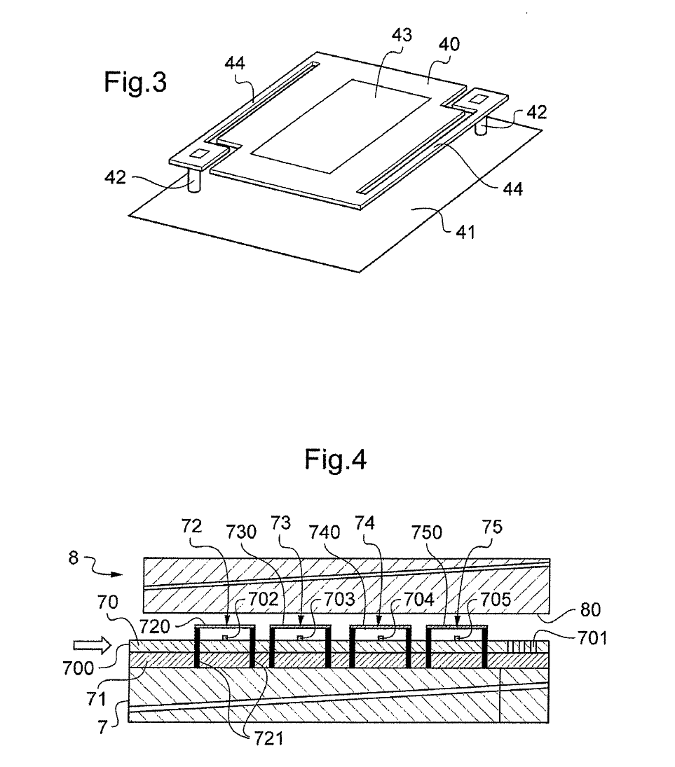

FIG. 3 is a perspective view of a bolometer example, as used in FIG. 2,

FIG. 4 is a side view of a spectroscopic device example according to the invention,

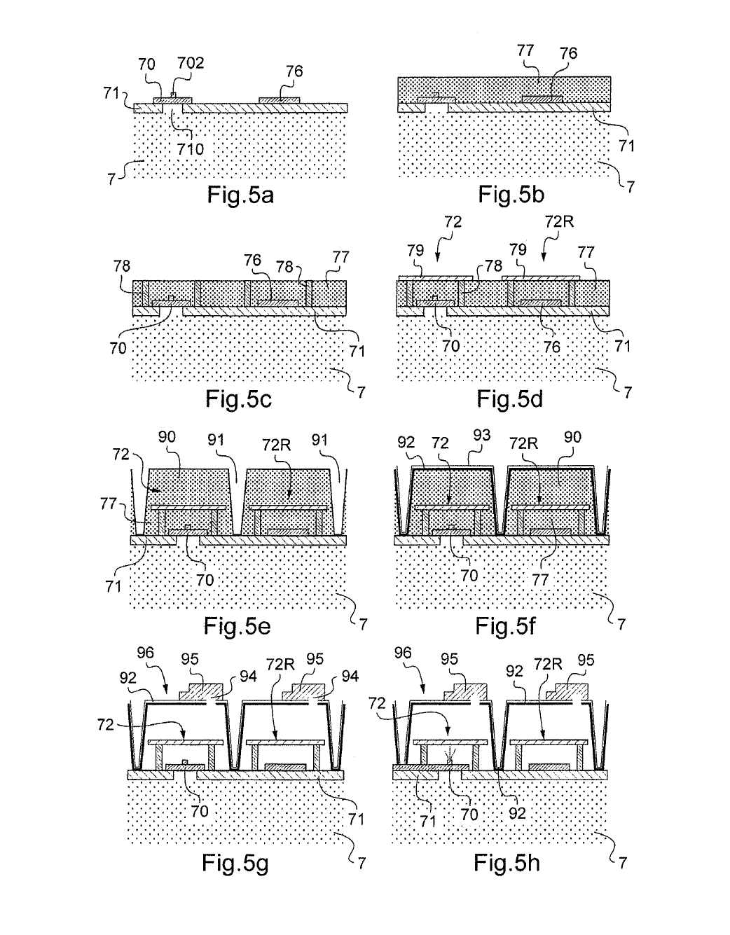

FIGS. 5a-5h are various steps for manufacturing the device illustrated in FIG. 4 and

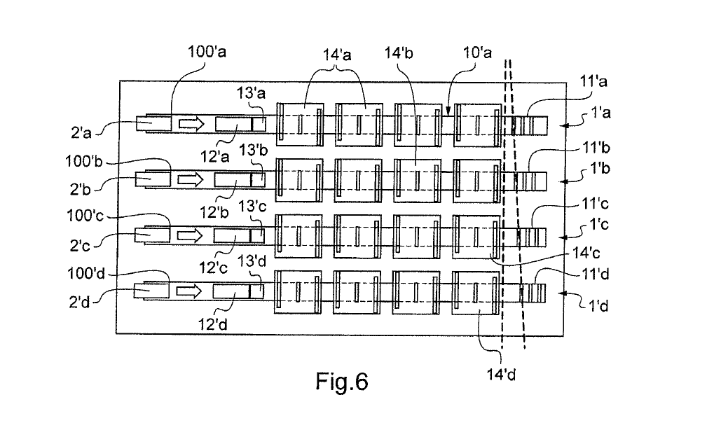

FIG. 6 is an alternative embodiment to FIG. 2.

FIG. 1 shows a detector example according to the invention.

This detector 1 includes a waveguide 10, the input face 100 of which is connected to an electromagnetic source 2. This is particularly an infrared source which can be a heat source, an infrared LED (Light Emitting Diode) or OLED (Organic LED) source or a wavelength tunable laser source, produced using the technology of quantum cascade lasers (QCL) which are suitable for infrared wavelengths.

A mirror 11 is provided on the face 101 of the waveguide, which is opposite the input face 100.

Therefore, in operation, a standing wave is generated within the waveguide by Lippmann effect.

Proximate the input face 100, the guide 10 includes a thinned area 12 which is connected to the rest of the waveguide by a filter 13.

The detector 1 also includes six heat detectors 14, which are arranged under the waveguide, while being spaced therefrom.

The distance between the waveguide and the heat detectors is of the order of the wavelength A of the standing wave or greater than λ. It is typically between approximately 2 μm and 20 μm.

In the illustrated example, these six detectors are substantially parallel with each other and perpendicular to the direction in which the waveguide extends.

Of course, the number of detectors is mentioned in this case simply by way of illustration. In practice, there will be a lot more.

Provided on the face of the waveguide opposite the detectors 14 and extending along the length of the waveguide are means for sampling a part of the standing electromagnetic wave which is present in the waveguide. These sampling means are symbolized by points 15 in FIG. 1.

These sampling means are arranged so as to be substantially opposite a detector 14.

They can consist of continuity breaks (holes or protuberances) produced at the surface of the waveguide or of diffusing blocks produced from a material with an index which is different to the environment surrounding the detector, i.e. a vacuum, for example, or with an index which is less than the guide or the core of the guide if the latter includes a coating.

These continuity breaks or these diffusing blocks allow a part of the wave to be unconfined and to be removed from the guide.

The spectroscopic detector 1 illustrated in FIG. 1 is intended to be used for the detection of gas.

Therefore, the thinned area 12 of the waveguide will be an area of interaction between the electromagnetic wave coming from the source, typically an infrared flux, and the gas. Thanks to this thinned part, the electromagnetic field of the wave is not only guided into the guide but spreads partially outside thereof. The field then interacts with the adjacent gas. This modifies the spectrum of the electromagnetic wave, this spectrum then being analyzed by means of the detectors 14.

Indeed, the detectors 14 are sensitive to the evanescent waves coming from the guide 10 and can therefore sample the intensity of the evanescent waves. The spectrum of the electromagnetic wave circulating in the waveguide can be established from the signals provided by the detectors 14.

The gas can then be detected by comparing the spectrum established by means of the detector 1 according to the invention and that of the electromagnetic wave coming from the source 2.

The invention is, however, not limited to this embodiment. The presence of the thinned area in the guide is only one possible interaction mode example, when the detector according to the invention is used to detect gas.

The filter 13 allows a spectral band of interest to be selected from the entire spectrum emitted by the source 2. It is not essential for the operation of the device 1.

It is understood that the pitch between the detectors and the length of the spectroscope, therefore the number of detectors, are linked to the features of the spectrum that is intended to be reconstructed. Generally, the smaller the pitch of the detectors, the greater the range of analysis of the spectrum without aliasing. Furthermore, the longer the spectroscope, the greater the resolution thereof.

Moreover, the operation of an interference spectroscope requires the pitch between the detectors to be, at the most, equal to half of the wavelength in the guide. For example, when the detector 1 is used to detect CO₂, the absorption wavelength of which is approximately 4.2 μm, with a guide index of approximately 4, the pitch between detectors will be approximately 0.5 μm, while the length of all of the detectors will be approximately 150 μm to a few millimeters. This corresponds to a set of approximately 300 detectors to a few thousand detectors.

For example, the guide 10 can be made from a silicon-germanium alloy, comprising the same percentage of silicon and germanium, the index of which is approximately 3.84, and include a coating of Si, the index of which is 3.42.

The dimensions of the guide will depend on the wavelength of the electromagnetic wave delivered by the source 2, as well as on the gas to be detected.

Therefore, when the device 1 is suitable to allow the detection of CO₂, the thickness of the guide will be approximately 0.6 μm, while the width thereof will be approximately 1.5 μm.

More generally, the width of the waveguide will typically be between 0.5 μm and 5 μm and the thickness thereof will be between 0.1 μm and 3 μm.

The mirror 11 can be produced by a metal deposit, or by structuring the end of the waveguide, obtained by etching incisions on the waveguide, allowing a Bragg grating to be obtained.

Likewise, the filter 13 can be obtained by etching incisions, such as to obtain a Bragg grating structure.

The diffusing blocks produced on the guide can have the same width as the guide. The length thereof can be a few microns and the thickness thereof can be a fraction of a micron. They can be produced by using the same material as the guide or the core of the guide, when the latter includes a coating, namely silica, silicon nitride, or silicon, or even SiGe, according to the wavelength range used by the detector.

Reference is now made to FIG. 2 which shows, in a plan and by way of example, four spectroscopic detectors according to the invention 1a-1b.

These four detectors are arranged in this case in a substantially parallel manner and they are identical.

Therefore, the heat detectors 14a, 14b, 14c and 14d form a matrix which is, preferably, arranged inside a housing 3 placed under vacuum.

Like the other spectroscopic detectors, the detector 1a is connected to a source 2a and it includes a waveguide with, in this example, a thinned part 12a, a filter 13a and a mirror 11a located on the side opposite the input face 100a thereof, connected to the source 2a.

In the example illustrated in FIG. 2, the spectroscopic detector 1a includes four heat detectors 14a arranged at a distance from the waveguide 10a.

The detectors 14a are uncooled heat infrared detectors and, more precisely, suspended-membrane bolometric detectors.

These bolometric detectors are used at room temperature. This means no specific cooling means need to be provided.

Generally, these detectors include an element made from a sensitive material which can be heated by an infrared radiation, which is characteristic of the temperature and of the emissivity of the observed body.

The temperature increase of the element produces a variation of an electrical property of the sensitive material: variation in capacity through change in the dielectric constant or variation in the resistance of a semiconductive or metal material. In an alternative, the sensitive material can have a p-n diode structure, or even be a thermocouple.

The detector can be encapsulated under vacuum or under a gas with low heat conductivity for improved performance.

Moreover, the performance of the heat detector is increased if three conditions are met at the sensitive material level: a low calorific mass, good insulation of the active layer with regard to the supporting means thereof and a large degree of sensitivity of the effect of converting heating into an electrical signal. These first two conditions mean that the sensitive material is in the form of a thin layer.

These bolometers are said to have a suspended membrane insofar as the sensitive material is arranged on a membrane which is spaced from the support substrate by anchoring points. The membrane is heated under the effect of incident radiation, which modifies the properties of the sensitive material. The spacing between the membrane and the anchoring points provides thermal insulation between the membrane and the substrate.

The detectors illustrated in FIG. 2 are resistive bolometric detectors. In these detectors, the incident radiation absorbed by the detector causes an increase in the temperature which produces a variation in the electrical resistance of a resistive material. These resistance variations produce variations in voltage or current at the terminals of the detector, these variations forming the signal delivered by the detector.

A resistive bolometric detector is illustrated, in perspective and in a simplified manner, in FIG. 3. Reference is also made to document FR-2 885 690 which describes such a detector.

It includes a fine membrane 40 intended to absorb the incident infrared radiation and convert it into heat. It is fixed to a support substrate 41 by means of anchoring points 42 which are electrically conductive. Therefore, it is suspended above this substrate. A layer 43 is deposited on the membrane 40 and functions as a thermometer. In operation, under the effect of infrared radiation, the membrane is heated and transmits the temperature thereof to the layer 43.

The thin layer 43 can be a thermistor.

The membrane 40 and the layer 43 generally rest on an insulating supporting means which provides the mechanical strength of the bolometric structure. It can also be encapsulated with one of these insulating materials, typically SiO₂, SiO or SiN.

Moreover, the sensitivity of the detector 4 is improved by providing insulating arms 44, between the support substrate 41 and the membrane 40. These insulating arms 44 allow the heat losses of the membrane to be limited and, consequently, the heating thereof to be preserved.

The support substrate 41 can be made up of an electronic circuit integrated onto a silicon wafer comprising devices for stimuli and reading the thermometer.

The electrical interconnection between the thermometer 43 and the reading devices provided on the substrate is provided by a layer, which is generally metal, arranged on the insulating arm 44.

For example, the membrane 40 can be p or n-type polycrystalline or amorphous silicon which is weakly or strongly resistive. A vanadium oxide (V₂O₅, VO₂), developed in a semiconductive phase, can also be envisaged.

The support substrate can be made from SiO₂, SiO, SiN, ZnS, for example.

The device illustrated in FIG. 2 can be designed such that the electronic circuits of all of the detectors are produced on the same silicon wafer. The multiplexing electronic components can also be produced on the latter.

This device allows four gas analyses to be carried out in parallel and therefore several types of gas to be detected simultaneously, at different wavelengths, thanks to the filters 13a-13d.

This allows the immunity to interfering gases to be increased and, therefore, the measurement performance to be increased.

Finally, each of the sources 2a-2d associated with each of the detectors 1a-1d can have a particular spectral range. This allows the detector to highlight the presence of a particular spectral line.

In an alternative embodiment illustrated in FIG. 6, the detectors 1′a-1′d are manufactured such that they are positionally offset in relation to the mirrors 11′a-11′d.

Therefore, the distance between the mirror 11′b and the input face 100′b is greater than the distance between the mirror 11′a and the input face 100′a and less than the distance between the mirror 11′c and the input face 100′c. Finally, the latter is less than the distance between the mirror 11′d and the input face 100′d. This spatial offset is illustrated by the two dotted lines in FIG. 6.

This spatial offset of the mirrors, from one detector to the other, produces a time lag which can be less than λ/4, λ being the effective wavelength of the wave in the guide. The Shannon sampling theorem is therefore met, while it is possible to accept a pitch between the detectors of approximately 10 λ, and therefore detectors of a large size.

The spatial offset can, for example, be approximately 5 pm from one detector to another.

FIG. 4 illustrates a spectroscopic detector according to the invention, which is produced from a single substrate.

A waveguide 70 and heat detectors, as well as the reading circuit thereof, are therefore formed on a substrate 7.

For example, the substrate 7 is made from silicon and deposited thereon are a silica and/or silicon nitride layer 71 and a silicon layer from which the guide 70 will be obtained using conventional techniques. Generally, the index n1 of the layer 71 is less than the index n2 of the constituent material of the waveguide. FIG. 4 does not illustrate a layer forming the coating of the waveguide.

In an alternative, the layer 71 can be completely removed in certain areas, using a photolithography and etching step. Thanks to the existence of these areas located about and under the guide, the latter is partially freed, which allows the losses thereof to be reduced.

The guide 70 is intended to be connected, via the input face 700 thereof, to an electromagnetic source, symbolized by an arrow in FIG. 4.

Moreover, the waveguide has a mirror 701 on the face thereof opposite the face 700.

Finally, diffusing blocks 702-705 are produced on the waveguide, on the face thereof extending along the length thereof and opposite the layer 71.

Produced on this same substrate are heat detectors, in this case bolometers, of which there is four. These bolometers 72-75 are, in this case, all identical.

By way of example, the bolometer 72 includes a membrane 720 which is fixed to the substrate 7 by means of anchoring points 721. This membrane 720 supports a thin layer, which functions as a thermometer, on the face thereof opposite the waveguide 70.

Each bolometer is developed on an organic layer which is removed after the formation of the anchoring points and of the membrane, by means of a plasma etching method.

As FIG. 4 illustrates, each membrane 720-750 of a detector is located facing a diffractive block 702-705.

It is therefore understood that, in this structure, the electromagnetic wave coming from the waveguide arrives on the membranes of each detector, on the side opposite the thin layer supported by this membrane.

Finally, several waveguides and several series of heat detectors could be produced on the substrate 7.

The reference 8 designates a cover which can be assembled on the substrate 7.

The connection between the substrate and the cover can be produced by means of various appropriate techniques such as to provide impermeability and to establish the spacing between the substrate and the cover.

Generally, these techniques are subject to several constraints. Firstly, impermeability should be ensured for quite a long duration, for example 15 years. Moreover these techniques should not result in altering the initial features of the bolometers provided on the substrate 7.

An example is therefore anodic sealing which uses borosilicate glass, which is largely doped with sodium or potassium.

Under the combined effect of a high electric field and a temperature of between 300° C. and 500° C., the ions migrate towards the anode and the cathode where they are trapped. The ions which are accumulated in this manner create a large internal electric field which provides the adhesion of the materials present.

Another fusion sealing technique can also be implemented with glasses having a low melting point.

These glasses can be previously deposited in a thin layer by cathode sputtering. Examples are particularly lead borates and in particular eutectics made up of a strong concentration of lead oxide and additions of B₂O₂, ZnO₂, SiO₂, Al₂O₃. All of these glasses have a melting temperature greater than 415° C. but allow sealing at temperatures lower than that necessary to melt a borosilicate glass, which is approximately 800° C.

Assembly can also be carried out by means of organic adhesives which are in the form of polymers or epoxides.

Sealing takes place at a low temperature, typically less than 200° C., which is indeed suitable for the detectors according to the invention due to the presence of the bolometers.

Finally, assembly can be achieved using a eutectic sealing technique.

As an alternative to this direct sealing, soldering can be carried out by providing a metal alloy, the melting temperature of which is compatible with the device. This alloy can be, for example, AuSn, InPb, SnPb.

This assembly allows the cavity defined by the substrate 7 and the cover 8 to be placed under vacuum.

Indeed, inside the cavity formed between the assembled substrate and cover, the vacuum is achieved at the moment of assembly, using vacuum sealing equipment. The vacuum must also be maintained in order for the heat detectors to operate properly. This vacuum can, for example, be obtained thanks to the insertion of films of materials absorbing the gas (getter). Examples are NEG (Non-Evaporable Getter) materials in particular. For example, the material sold under the name St122 by the company SAES can be used. It has the advantage of having a relatively low activation temperature (300° C.-500° C.).

It is understood that, in this embodiment, no reflector is associated with the bolometer, which can lead to a limitation in the performance of the detector.

A reflecting layer can also be provided on the face 80 of the cover 8, opposite the substrate 7. This reflecting layer allows the performance of the detector to be increased.

A method for producing a spectroscopic detector according to the invention will now be described with reference to the FIGS. 5a-5h which show some steps thereof.

FIGS. 5a-5g are views in a plane perpendicular to the direction in which the guide 70 extends.

This detector is the type of detector illustrated in FIG. 4, the cover 8 being replaced by a plurality of individual covers, which are each intended for a given detector.

FIG. 5a shows a first step of the method.

Firstly, a layer 71, then another layer from which the waveguide 70 and another waveguide 76 will be obtained, have been deposited on the substrate 7.

For example, the substrate 7 is made of silicon, the layer 71 can be made from silica, SiO or SiN and the guides 70 and 76 can be obtained from a layer of SiGe.

Firstly, the reading and addressing electronic circuit intended for the bolometers is produced on the substrate 7.

The waveguides 70 and 76 are obtained using lithography conventional techniques.

FIG. 5a shows that, in this example, the layer 71 has been removed in the area 710, thanks to a step of photolithography and etching.

Therefore, at this area 710, the guide 70 is partially freed, which allows the losses thereof to be reduced.

A means 702 for sampling the electromagnetic wave is produced on the guide 70, using a microtechnology conventional method, such as chemical etching or plasma etching, or a lift-off method. By contrast, no similar means is produced on the guide 76 which remains optically inactive.

The step illustrated in FIG. 5b consists in depositing a sacrificial layer 77 on the waveguides 70 and 76.

This sacrificial layer can particularly be produced from polyimide. The thickness thereof can be between 1 μm and 10 μm.

FIG. 5c illustrates another step consisting in producing the anchoring points of the future bolometers.

Firstly, the sacrificial layer 77 is etched, for example by a using a plasma etching method. The anchoring points 78 are then produced by electrolysis, by cathode sputtering or by thermal (Low Pressure Chemical Vapor Deposition (LPCVD)) or plasma (Plasma-Enhanced Chemical Vapor Deposition (PECVD)) decomposition.

These anchoring points can be made from aluminum, copper or tungsten for example.

The elements for connecting the bolometers to the electronic circuit that is associated therewith are then produced.

FIG. 5d illustrates a step of the method wherein the membranes of each detector are produced as well as the thin layer that they support, on the face thereof opposite the substrate 7.

Therefore, the various constituent layers of the bolometric structure are successively deposited on the sacrificial layer 77.

Therefore, a layer made from insulating material, such as Si₂O, SiN or ZnS, is firstly deposited.

A film intended to absorb incident infrared radiation and convert it into heat is then deposited on this insulating layer.

This film is typically made from metal and it has a thickness of between 5 nm and 10 nm.

Finally, a layer of a thermometric material, such as an amorphous or polycrystalline chemical or semiconducting material, is deposited on this film. This is typically Si, Ge, SiC, a-Si:H, a-SiC:H or a-SiGe:H.

The thickness of the layer of thermometric material is typically between 50 nm and 500 nm.

The layers of absorbent material and thermometric material are obtained using low-temperature deposition techniques, which are normally used for these materials. Examples are particularly cathode sputtering, thermal (LPCVD) or plasma (PECVD) decomposition techniques.

The possible doping of these layers is carried out by introducing a doping gas, such as BF3 or PH3, into the reactor or by ion implantation.

After the deposition of these three layers, an etching step is carried out such as to form individualized membranes supported by the anchoring points 78.

The etching of these layers is generally carried out using plasma-assisted chemical etching methods.

FIG. 5d therefore illustrates a membrane 79 forming, together with the pillars 78, a bolometer 72 above the guide 70.

On the right-hand side of FIG. 5d, above the guide 76, another bolometer 72R is formed which will be used as a reference bolometer.

It can be noted that with other technologies the bolometers can be produced directly on the substrate, without requiring the deposition of a sacrificial layer on the waveguide.

During the operation of the spectroscopic detector which will be obtained, the reference bolometers will allow departure from the common operating modes, thanks to a differential assembly, and temperature fluctuations of the substrate to be overcome. They therefore allow the sensitivity of the measurement carried out by the detector to be increased. The presence thereof and the number thereof depend on the desired performance.

With reference to FIG. 5e, the following step consists in depositing a second sacrificial layer 90 on the previously produced bolometers.

Preferably, the thickness of this layer 90 corresponds substantially to a quarter of the wavelength of the light transported in the guide 70. This allows an optical cavity to be produced above the guide which concentrates the electromagnetic field on the bolometric detector and therefore increases the coupling between the guide and the detector. An etching step is then carried out, thanks to which the bolometers are separated from one another. Therefore, free spaces 91 are arranged between two adjacent bolometers.

FIG. 5f illustrates the steps of depositing two successive layers on the sacrificial layer 90.

The first deposited layer 92 is a metal layer and forms the reflector of the bolometer 72 present above the guide 70 and of the reference bolometer 72R.

The second layer 93 is provided for the thermal stability and/or the passivation of the reflector. This layer can be omitted.

The layer 92 can particularly be made from Ti, TiN, Pt, Al, Pd, Ni or NiCr.

This layer 92 can particularly be deposited by cathode sputtering or by thermal (LPCVD) or plasma (PECVD) decomposition. The thickness thereof is typically between 0.005 μm and 1 μm.

The layers 92 and 93 can be used for the vacuum encapsulation of each of the bolometers. They then completely surround each bolometer and these layers will be hermetic.

The sacrificial layers 77 and 90 should then be removed to free the bolometers.

Therefore, a vent 94 is made through the layers 92 and 93.

This vent is obtained by depositing a sacrificial layer on the whole structure illustrated in FIG. 5f and by plasma etching it.

The sacrificial layers 77 and 90 can then be removed, also by using a radiofrequency or microwave plasma etching technique.

FIG. 5g illustrates the last step of the production method according to the invention which consists in depositing at least one layer 95, such as to encapsulate, individually and under vacuum, each of the bolometers produced on a substrate 7.

FIG. 5h is a view of the device illustrated in FIG. 5g but in a plane parallel to the direction in which the waveguide 70 extends.

It shows that the layer 92 can be directly in contact with the layer 71 or in contact with the waveguide.

Therefore, in the spectroscopic detector obtained from the method which has just been described, each bolometer is individually placed under vacuum. Each impervious housing 96 formed about a bolometer includes a reflector in the upper part thereof.

The obtained detectors have numerous advantages.

Firstly, as for the detector illustrated in FIG. 4, all of the waveguides and bolometers can be produced on a single substrate. This considerably simplifies the manufacture thereof.

Moreover, each bolometer is associated with a reflector, and this allows the sensitivity of the device to be increased.

Finally, the performance of the detector is not affected by the deflection which can arise, due to the housings being placed under vacuum.

Indeed, this deflection is relatively small due to the small size of the housings. Moreover, it is substantially the same for all of the bolometers and the quality of the measurement is therefore not affected thereby.

The sole aim of the references inserted after the technical features in the claims is to facilitate the understanding of the latter and they cannot limit the scope thereof.

1. A method of manufacturing a spectroscopic detector including the following steps wherein:
a waveguide is produced on a substrate, the waveguide having an input face intended to be connected to an electromagnetic source, in particular an infrared source, and a mirror on the opposite face, so as to generate a standing wave within the waveguide;
means for sampling a part of the electromagnetic wave are produced between the input face and the mirror;
a plurality of suspended-membrane bolometers is produced on said substrate, which bolometers are intended to deliver an electrical signal dependent upon the local intensity of the electromagnetic wave, each membrane being spaced from the waveguide by anchoring points on the substrate.

2. A spectroscopic detector comprising:
at least one waveguide arranged on a substrate and having an input face intended to be connected to an electromagnetic source, in particular an infrared source, and a mirror on the opposite face, so as to generate a standing wave within the waveguide, and
means for detecting electromagnetic radiation, delivering an electrical signal dependent upon the local intensity of the electromagnetic wave, characterized in that said detection means are suspended-membrane bolometers, distributed between the input face and the mirror, each membrane of said heat detectors being spaced from said at least one waveguide by anchoring points on said substrate,
and in that means for sampling a part of the electromagnetic wave are provided between the input face and the mirror.

3. The detector as claimed in claim 2, wherein said sampling means are produced at the surface of the waveguide.

4. The detector as claimed in claim 3, wherein said sampling means are made up of blocks arranged on the surface of the waveguide and produced from a material with an index which is different to that of the surrounding environment or of the waveguide.

5. The detector as claimed in claim 3, wherein said sampling means are continuity breaks produced at the surface of the waveguide.

6. The detector as claimed in claim 2, wherein said detector also includes a cover to allow the bolometers to be placed under vacuum.

7. The detector as claimed in claim 6, wherein the cover is shared by all of the bolometers.

8. The detector as claimed in claim 6, wherein the cover is made up of a plurality of individual covers, each intended for a bolometer.

9. The detector as claimed in claim 8, wherein each individual cover includes a reflector intended for the bolometer that it covers.

10. The spectroscopic detector including a plurality of detectors as claimed in claim 2, which are arranged to form a matrix.

11. A gas detector comprising a spectroscopic detector as claimed in claim 2.
